(19) United States
(12) Patent Application Publication
(10) Pub. No.: US 2025/0329490 A1
(43) Pub. Date: Oct. 23, 2025

(54) INDUCTIVE CHARGING SYSTEM FOR AN ELECTRIC VEHICLE

(71) Applicant: Wireless PnC Inc., Victoria (CA)

(72) Inventors: Francisco J. Perez-Pinal, Ciudad de México (MX); Ibsan Castillo, Ciudad de México (MX); Sheldon Williamson, Oshawa (CA); Phuoc Sang Huyn, Oshawa (CA); Deepa Vincent, Oshawa (CA)

(73) Assignee: Wireless PnC Inc., Victoria (CA)

(21) Appl. No.: 18/637,816

(22) Filed: Apr. 17, 2024

(51) Int. Cl. H01F 27/28; B60L 53/12; H02J 50/00; H02J 50/10; H02J 50/70

(52) U.S. Cl. CPC H01F 27/2885; B60L 53/12; H02J 50/005; H02J 50/10; H02J 50/70

(57) ABSTRACT

An inductive charging system for charging an electric vehicle, the inductive charging system comprising: an onboard vehicle assembly, which includes a receiver module comprising a receiver coil that defines a central aperture, an apertured metal shielding layer and a series of ferrite bars between the receiver coil and the apertured metal shielding layer, the series of ferrite bars radiating outward from the central aperture; and a charging station assembly, which includes a transmitter module comprising a transmitter coil that defines a central aperture, an apertured metal shielding layer and a series of ferrite bars between the transmitter coil and the apertured metal shielding layer, the series of ferrite bars radiating outward from the central aperture, wherein the receiver coil and the transmitter coil are a matching geometry of polygons having four to ten sides with central apertures that are a matching geometry to the matching geometry of polygons.

### FIELD

The present technology is related to a lightweight inductive charging system with low electromagnetic interference. More specifically, it is a transmitter module and a receiver module that each include a coil, ferrite bars and a metal honeycomb layer.

### BACKGROUND OF THE INVENTION

Several technologies have been developed to introduce wireless charging in electric vehicles by installing an inductive charging station in a parking area and receiver module in the electrical vehicle. Power is transferred using a non-contact magnetic induction. Although wireless charging is considered to be safer than wired charging, wireless charging has some disadvantages including: electromagnetic field emission in the vicinity of the transmitter and receiver coils that may have adverse effects on devices and/or people in the vicinity; the electrical and electronic components connected to the receiver coil may absorb the emitted electromagnetic field from the receiver and transmitter resulting in eddy current losses and heating in these components; low efficiency of charging; and large, heavy coils.

Technologies have been developed to address these issues such as U.S. Pat. No. 11,349,315, which discloses a system for inductive charging of electronic devices. An inductive charger includes an enclosure with a charging surface, an inductive charging coil, and a metallic shield layer. The coil includes a spiral-shaped conductor that transmits power through the charging surface with an alternating magnetic field when an electronic device is positioned in proximity to the charging surface. The shield layer is positioned between the conductor and the charging surface such that the shield layer covers the conductor, and it provides a frequency-dependent response in which transmission of electromagnetic power through the shield layer is allowed in the frequency range while transmission of electromagnetic interference noise through the first shield layer is attenuated at frequencies higher than the frequency range. Disclosed are various shapes of coils, including mosaics of hexagonal coils, which in one embodiment are arranged as a larger hexagon. Regardless of shape, there is a central port in each coil where it is attached to a printed circuit board. The inductive charger is large and complex, thus requiring a large receiver coil.

United States Patent Application Publication No. 20190225098 discloses an inductive charging unit for a vehicle that includes a trough-shaped base support having a base surface and the base surface has laterally enclosing side walls where the base surface and the side walls form a trough. The charging unit further includes a top surface opposite the base surface and a primary coil for inductive coupling to a secondary coil associated with the vehicle, where the primary coil is disposed in the trough. A filling material is disposed in the trough and surrounds the primary coil so as to fix the primary coil mechanically. The filling material provides containment for electromagnetic radiation that might normally escape.

U.S. Pat. No. 11,606,119 discloses an inductive charging system for inductive charging of electronic devices. In accordance with an embodiment, the system includes a substantially planar inductive charging coil parallel to the surface of the inductive charger of the electronic device. The system further includes a metallic layer positioned proximate to and substantially parallel to the inductive coil to cover a surface of the inductive coil. The metallic layer comprises multiple substantially concentric rings or polygons, with each of the concentric rings or polygons having multiple sections separated by gaps such that each concentric ring or polygon is discontinuous. Adjacent sections of each concentric ring or polygon are electrically isolated from one another to avoid eddy current generation and heating of the metallic layer during inductive power transfer. This is a complex charging system. The coils would not be lightweight.

What is needed is a lightweight, cost-effective inductive charging system. It would be preferable if the transmitter coil had low electrical resistance to reduce power consumption. It would be preferable if the transmitter coil and the receiver coil had a high coupling coefficient. It would be further preferable if the transmitter coil and the receiver coil became an essentially closed system during charging. It would be preferable if the coils were shaped to reduce the proximity effect. It would be preferable if the receiver module could be used to retrofit an electric vehicle.

### SUMMARY OF THE INVENTION

The present technology is a light weight, compact, cost-effective inductive charging system. The transmitter coil has low electrical resistance to reduce power consumption. The transmitter coil and the receiver coil have a high coupling coefficient. Both the receiver module and the transmitter module of the inductive charging system include ferrite bars and a honeycomb shielding layer. The transmitter coil and the receiver coil are an essentially closed system during charging. The coils are matching polygons of at least four sides and up to ten sides to reduce the proximity effect. The coils include a central to allow release of magnetic flux. The receiver module can be used to retrofit an electric vehicle.

In one embodiment, an inductive charging system is provided for charging an electric vehicle, the inductive charging system comprising: an onboard vehicle assembly, which includes a receiver module comprising a receiver coil that defines a central aperture, an apertured metal shielding layer and a series of ferrite bars between the receiver coil and the apertured metal shielding layer, the series of ferrite bars radiating outward from the central aperture; and a charging station assembly, which includes a transmitter module comprising a transmitter coil that defines a central aperture, an apertured metal shielding layer and a series of ferrite bars between the transmitter coil and the apertured metal shielding layer, the series of ferrite bars radiating outward from the central aperture, wherein the receiver coil and the transmitter coil are a matching geometry of polygons having four to ten sides with central apertures that are a matching geometry to the matching geometry of polygons.

In the inductive charging system, the matching geometry of polygons may be a hexagon.

In the inductive charging system, the apertured metal shielding layer may be a honeycomb metal shielding layer.

In the inductive charging system, the honeycomb metal shielding layer may define a void volume that is greater than a metal volume.

In the inductive charging system, the void volume may be 75% to 90% and the metal volume may be 25% to 10%.

In the inductive charging system, the honeycomb metal shielding layer may consist of aluminum.

In the inductive charging system, the ferrite bars may be L-shaped.

In the inductive charging system, the receiver coil and the transmitter coil may have a total area that is the same.

In the inductive charging system, the receiver coil may have a total area that is one half a total area of the transmitter coil.

In the inductive charging system, the onboard vehicle assembly may further comprise a rechargeable battery that is in electrical communication with the receiver coil.

In the inductive charging system, each central aperture may occupy a quarter of the total area of each of the receiver coil and the transmitter coil.

In the inductive charging system, the charging station assembly may be configured for mounting in a horizontally disposed substrate.

In the inductive charging system, the charging station assembly may be configured for mounting on a vertical surface.

In another embodiment, a transmitter module is provided for charging an electric vehicle, the transmitter module comprising a hexagonal, copper wire coil that defines a hexagonal central aperture, a honeycomb construction metal shielding layer and a series of L-shaped ferrite bars between the copper wire coil and the honeycomb construction metal shielding layer, the series of L-shaped ferrite bars radiating outward from the central aperture and cradling the hexagonal, copper wire coil.

In the transmitter module, the honeycomb metal shielding layer may consist of aluminum.

In the transmitter module, the hexagonal central aperture may be a quarter of a total area of the hexagonal, copper wire coil.

In another embodiment, an electric vehicle is provided, the electric vehicle comprising a vehicle and a receiver module which is housed in the vehicle, the receiver module comprising a hexagonal, copper wire receiver coil that defines a hexagonal central aperture, a honeycomb construction metal shielding layer and a series of L-shaped ferrite bars between the copper wire coil and the honeycomb construction metal shielding layer, the series of L-shaped ferrite bars radiating outward from the central aperture and cradling the hexagonal, copper wire receiver coil.

In the electric vehicle, the hexagonal central aperture may be a quarter of a total area of the hexagonal, copper wire receiver coil.

The electric vehicle may further comprise a rechargeable battery that is in electrical communication with the hexagonal, copper wire receiver coil.

The electric vehicle may be selected from the group consisting of an electric car, a hybrid car, an electric truck, a hybrid truck, an electric boat, a hybrid boat, an electric scooter, a hybrid scooter, an electric motorcycle and a hybrid motorcycle.

### BRIEF DESCRIPTION OF DRAWINGS

FIG. 1 is a side view schematic of the charging system of the present technology, shown in an electric vehicle and in a substrate.

FIG. 2 is a schematic of an isometric view of the transmitter module of the charging system of FIG. 1.

FIG. 3 is a schematic of an isometric view of the receiver module of the charging system of FIG. 1.

FIG. 4 is a schematic of an isometric view of the receiver module and the transmitter module.

### DESCRIPTION OF THE INVENTION

Except as otherwise expressly provided, the following rules of interpretation apply to this specification (written description and claims): (a) all words used herein shall be construed to be of such gender or number (singular or plural) as the circumstances require; (b) the singular terms “a”, “an”, and “the”, as used in the specification and the appended claims include plural references unless the context clearly dictates otherwise; (c) the antecedent term “about” applied to a recited range or value denotes an approximation within the deviation in the range or value known or expected in the art from the measurements method; (d) the words “herein”, “hereby”, “hereof”, “hereto”, “hereinbefore”, and “hereinafter”, and words of similar import, refer to this specification in its entirety and not to any particular paragraph, claim or other subdivision, unless otherwise specified; (e) descriptive headings are for convenience only and shall not control or affect the meaning or construction of any part of the specification; and (f) “or” and “any” are not exclusive and “include” and “including” are not limiting. Further, the terms “comprising,” “having,” “including,” and “containing” are to be construed as open-ended terms (i.e., meaning “including, but not limited to,”) unless otherwise noted.

Recitation of ranges of values herein are merely intended to serve as a shorthand method of referring individually to each separate value falling within the range, unless otherwise indicated herein, and each separate value is incorporated into the specification as if it were individually recited herein. Where a specific range of values is provided, it is understood that each intervening value, to the tenth of the unit of the lower limit unless the context clearly dictates otherwise, between the upper and lower limit of that range and any other stated or intervening value in that stated range, is included therein. All smaller sub ranges are also included. The upper and lower limits of these smaller ranges are also included therein, subject to any specifically excluded limit in the stated range.

Unless defined otherwise, all technical and scientific terms used herein have the same meaning as commonly understood by one of ordinary skill in the relevant art. Although any methods and materials similar or equivalent to those described herein can also be used, the acceptable methods and materials are now described.

### Definitions

Apertured metal electromagnetic field shield—in the context of the present technology, an apertured metal electromagnetic field shield is one of a single metal mesh layer that defines apertures, multiple metal mesh layers which together define the apertures and a perforated metal layer in which the perforations define the apertures.

Honeycomb metal electromagnetic field shield—in the context of the present technology, a honeycomb metal electromagnetic field shield is a specific form of a perforated metal layer in which the metal is formed to define honeycomb-shaped apertures.

Electric vehicle—in the context of the present technology, an electric vehicle includes an electric car, a hybrid car, an electric truck, a hybrid truck, an electric boat, a hybrid boat, an electric scooter, a hybrid scooter, an electric motorcycle, a hybrid motorcycle and the like.

### DETAILED DESCRIPTION

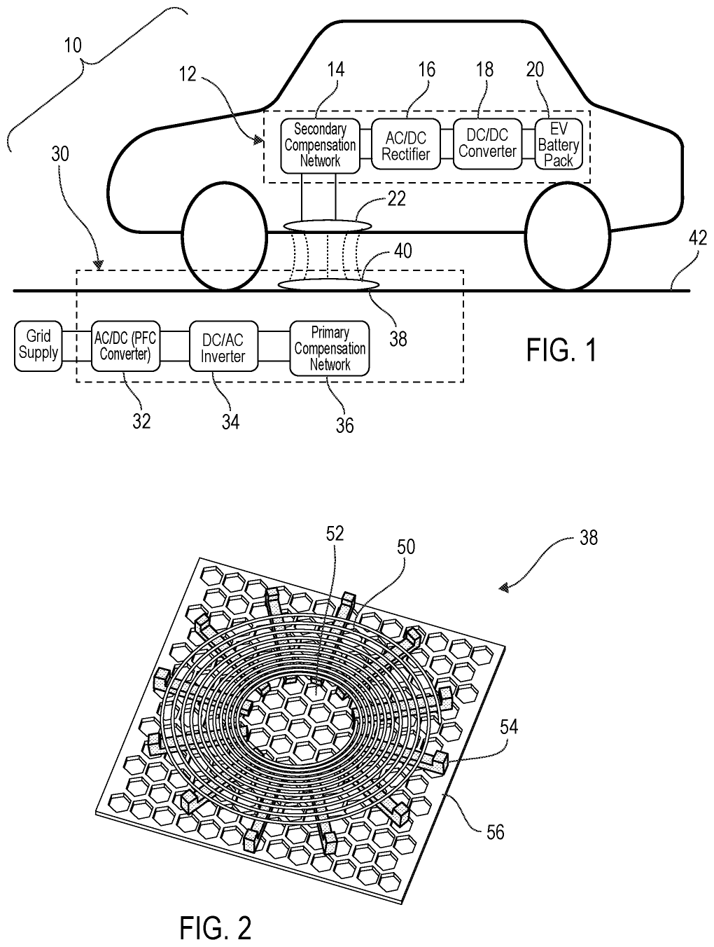

An inductive charging system, for use in an electric vehicle and for locating at a charging station, generally referred to as 10 is shown in FIG. 1. The onboard vehicle assembly, generally referred to as 12, includes a secondary compensation network 14, an alternating current/direct current (AC/DC) rectifier 16, a direct current/direct current (DC/DC) converter 18, a rechargeable battery pack 20 and a receiver module 22. In an embodiment, the electric vehicle is an automobile. The charging station assembly, generally referred to as 30, includes an AC/DC converter 32, a DC/AC inverter 34, a primary compensation network 36 and a transmitter module 38. In the embodiment of FIG. 1, the charging station assembly 30 is in a substrate, for example, but not limited to an outdoor parking stall, a parking garage stall or a driveway, with at least an upper surface 40 of transmitter module 38 being exposed to the ambient environment. In this embodiment, as shown in FIG. 1, the receiver module 22 is located on an underside of the electric vehicle. In use, the driver drives the electric vehicle over the charging station assembly 30, aligning the receiver module 22 with the transmitter module 38. In another embodiment, the components 32, 34, 36 of the charging station assembly 30 are located remote to the transmitter module 38, which is located in the substrate such that the upper surface 40 is exposed to the ambient, while remaining in electrical communication with the transmitter module 30. In yet another embodiment, the receiver module 22 is located on the surface 42 of the substrate.

In another embodiment the charging station assembly 30 is mounted on a vertical surface, for example, but not limited to an exterior wall of a house, an interior wall of a parking garage, a post, a framework or a dock. The receiver module 22 is located on the front or the back of the electric vehicle, although it could be mounted on the side of the electric vehicle. In another embodiment, the components 32, 34, 36 of the charging station assembly 30 are located remote to the transmitter module 38, which is located on the vertical surface, while remaining in electrical communication with the transmitter module 38.

As shown in FIG. 2, the transmitter module 38 consists of a hexagonal transmitter coil 50, which has a hexagonal central aperture 52, a series of L-shaped ferrite bars 54 which extend outward from the central aperture 52 and a honeycomb metal shielding layer 56. The L-shaped ferrite bars 54 are between the hexagonal transmitter coil 50 and the honeycomb metal shielding layer 56 and cradle the hexagonal transmitter coil 50. Without being bound to theory, the hexagonal shape with a central aperture 52 provides a lightweight coil that directs magnetic flux through the central aperture 52, the L-shaped ferrite bars 54 enhance self-inductance and improve the coupling coefficient and the honeycomb metal shielding layer results in improved directionality of the electromagnetic field, in addition to distributing mechanical stresses evenly. In the preferred embodiment, the metal is aluminum. This provides a means of dissipating heat generated during charging. In another embodiment, the L-shaped ferrite bars 54 are replaced with straight ferrite bars. In another embodiment, the hexagonal transmitter coil 50 is replaced with a polygon of at least four sides and up to ten sides, each with a central aperture 52 of the same geometry as the polygon. In one embodiment, the honeycomb metal shielding layer 56, while providing superior strength with a minimal amount of material, is replaced with a perforated metal layer as the shielding layer. In yet another embodiment, the honeycomb construction metal shielding layer 56 is replaced with at least one layer of metal mesh, the final layer or layers of metal mesh having the same ratio of void volume to metal volume as the honeycomb construction metal shielding layer 56.

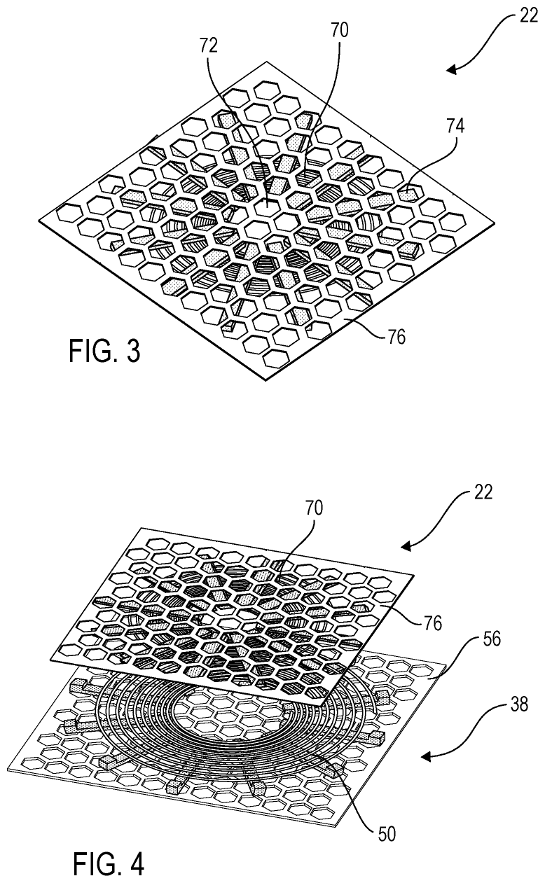

As shown in FIG. 3, the receiver module 22 consists of a hexagonal receiver coil 70, which has a hexagonal central aperture 72, a series of L-shaped ferrite bars 74 which extend outward from the central aperture 72 and a honeycomb metal shielding layer 76. The receiver coil 70 is in electrical communication with the rechargeable battery 20. The L-shaped ferrite bars 74 are between the hexagonal receiver coil 70 and the honeycomb metal shielding layer 76 and cradle the hexagonal receiver coil 70. Without being bound to theory, the hexagonal shape with a central aperture 72 provides a lightweight coil that directs magnetic flux through the central aperture 72, the L-shaped ferrite bars 74 enhance self-inductance and improve coupling coefficient and the honeycomb metal shielding layer results in improved directionality of the electromagnetic field, in addition to distributing mechanical stresses evenly. In the preferred embodiment, the metal is aluminum. This provides a means of dissipating heat generated during charging. In another embodiment, the L-shaped ferrite bars 74 are replaced with straight ferrite bars. In another embodiment, the hexagonal receiver coil 22 is replaced with a polygon of at least four sides and up to ten sides, each with a central aperture, the polygon matching the polygon of the transmitter coil 50. The central aperture is of the same geometry as the polygon. In one embodiment, the honeycomb metal shielding layer 76, while providing superior strength with a minimal amount of material, is replaced with a perforated metal layer as the shielding layer. In yet another embodiment, the honeycomb metal shielding layer 76 is replaced with at least one layer of metal mesh, the final layer or layers of metal mesh having the same ratio of void volume to metal volume as the honeycomb metal shielding layer 76.

The ratio of diameter of the apertures 52, 72 to the hexagonal transmitter coil 50 or the hexagonal receiver coil is about 1:2. This represents about a quarter of the total area of each coil. The honeycomb metal shielding layers 56, 76 are about 3 millimeters to about 7 millimeters thick. As can be understood from the figures, the void volume of the honeycomb metal shielding layer 56, 76 is greater than the volume of the metal and occupies about 75% to 90% of the volume.

As shown in FIG. 4, the receiver module 22 and the transmitter module 38 are proximate to one another during charging, with the metal honeycomb shielding layers 56, 76 forming the outer surface of each module 22, 38. The two coils 50, 70 are aligned laterally and angularly. The combined hexagonal coils 50, 70 and honeycomb aluminum shielding layers 56, 76 protects a user from unwanted electromagnetic radiation, provides greater efficiency due to minimal wastage of power and minimizes electromagnetic interferences with the nearby electronic devices in the vicinity of the inductive charging system 10 during charging of the battery. In one embodiment the receiver coil 70 is of a smaller diameter relative to the transmitter coil 50. In another embodiment, the receiver coil 70 has the same diameter as the transmitter coil 50. In an exemplary embodiment, the receiver coil 70 is half the area of the transmitter coil 50. The coils 50,70 are constructed of Litz wire or printed circuit board wire or a combination thereof. These are copper wires.

Table 1 shows a comparison between the hexagonal coil, a square coil and a circular coil, all with a central aperture. Each coil is made with 20 turns and the wire gauge is set at American Wire Gauge (AWG) 6 with 3200 strands. The hexagonal coil has the smallest volume. Finite element analysis of the coil (L_{FEA}) shows that the hexagonal coil has the lowest self-inductance.

TABLE 1

| | Outside | Aperture | | | L_{FEA} |
|---|---|---|---|---|---|
| | diameter | diameter | Volume | L_{FEA} | Volume |
| Coil | (mm) | (mm) | (mm³) | (μH) | (mm) |
| Circular | 329.2 | 164.6 | 262688 | 124.95 | 0.475 × 10⁻³ |
| Square | 329.2 | 164.6 | 334465 | 123.06 | 0.370 × 10⁻³ |
| Hexagonal | 333.3 | 164.6 | 217241 | 115.66 | 0.532 × 10⁻³ |

Table 2 shows a comparison in the electromagnetic properties between the hexagonal coil, the square coil and the circular coil, all with a central aperture. Each coil is made with 26 turns. The hexagonal coil exhibited the highest coupling coefficient and the lowest self-inductance compared to the square coil and the circular coll. The magnetic field density of each coil was compared at 900 mm away from the centre of the primary coils as 900 mm is approximately the half of the average overall width of electric vehicles. The hexagonal coil exhibited the lowest electromagnetic field exposure compared to the other coils.

TABLE 2

| | | Coupling | Self | Magnetic |
|---|---|---|---|---|
| | Volume | co-efficient | inductance | field |
| Coil | (mm³) | (k) | (μH) | (μT) |
| Circular | 552343 | 0.1622 | 448.38 | 6.921 |
| Square | 565245 | 0.1605 | 492.78 | 7.257 |
| Hexagonal | 489517 | 0.1629 | 431.00 | 6.694 |

While example embodiments have been described in connection with what is presently considered to be an example of a possible most practical and/or suitable embodiment, it is to be understood that the descriptions are not to be limited to the disclosed embodiments, but on the contrary, is intended to cover various modifications and equivalent arrangements included within the spirit and scope of the example embodiment. Those skilled in the art will recognize or be able to ascertain using no more than routine experimentation, many equivalents to the specific example embodiments specifically described herein. Such equivalents are intended to be encompassed in the scope of the claims, if appended hereto or subsequently filed.

1. An inductive charging system for charging an electric vehicle, the inductive charging system comprising: an onboard vehicle assembly, which includes a receiver module comprising a receiver coil that defines a central aperture, an apertured metal shielding layer and a series of ferrite bars between the receiver coil and the apertured metal shielding layer, the series of ferrite bars radiating outward from the central aperture; and a charging station assembly, which includes a transmitter module comprising a transmitter coil that defines a central aperture, an apertured metal shielding layer and a series of ferrite bars between the transmitter coil and the apertured metal shielding layer, the series of ferrite bars radiating outward from the central aperture, wherein the receiver coil and the transmitter coil are a matching geometry of polygons having four to ten sides with central apertures that are a matching geometry to the matching geometry of polygons.

2. The inductive charging system of claim 1, wherein the matching geometry of polygons is a hexagon.

3. The inductive charging system of claim 2, wherein the apertured metal shielding layer is a honeycomb metal shielding layer.

4. The inductive charging system of claim 3, wherein the honeycomb metal shielding layer defines a void volume that is greater than a metal volume.

5. The inductive charging system of claim 4, wherein the void volume is 75% to 90% and the metal volume is 25% to 10%.

6. The inductive charging system of claim 4, wherein the honeycomb metal shielding layer consists of aluminum.

7. The inductive charging system of claim 6, wherein the ferrite bars are L-shaped.

8. The inductive charging system of claim 1, wherein the receiver coil and the transmitter coil have a total area that is the same.

9. The inductive charging system of claim 1, wherein the receiver coil has a total area that is one half a total area of the transmitter coil.

10. The inductive charging system of claim 6, wherein the onboard vehicle assembly further comprises a rechargeable battery that is in electrical communication with the receiver coil.

11. The inductive charging system of claim 9, wherein each central aperture occupies a quarter of the total area of each of the receiver coil and the transmitter coil.

12. The inductive charging system of claim 1, wherein the charging station assembly is configured for mounting in a horizontally disposed substrate.

13. The inductive charging system of claim 12, wherein the charging station assembly is configured for mounting on a vertical surface.

14. A transmitter module for charging an electric vehicle, the transmitter module comprising a hexagonal, copper wire coil that defines a hexagonal central aperture, a honeycomb construction metal shielding layer and a series of L-shaped ferrite bars between the copper wire coil and the honeycomb construction metal shielding layer, the series of L-shaped ferrite bars radiating outward from the central aperture and cradling the hexagonal, copper wire coil.

15. The transmitter module of claim 14, wherein the honeycomb metal shielding layer consists of aluminum.

16. The transmitter module of claim 15, wherein the hexagonal central aperture is a quarter of a total area of the hexagonal, copper wire coil.

17. An electric vehicle, the electric vehicle comprising a vehicle and a receiver module which is housed in the vehicle, the receiver module comprising a hexagonal, copper wire receiver coil that defines a hexagonal central aperture, a honeycomb construction metal shielding layer and a series of L-shaped ferrite bars between the copper wire coil and the honeycomb construction metal shielding layer, the series of L-shaped ferrite bars radiating outward from the central aperture and cradling the hexagonal, copper wire receiver coil.

18. The electric vehicle of claim 17, wherein the hexagonal central aperture is a quarter of a total area of the hexagonal, copper wire receiver coil.

19. The electric vehicle of claim 18, wherein the vehicle further comprises a rechargeable battery that is in electrical communication with the hexagonal, copper wire receiver coil.

20. The electric vehicle of claim 17, wherein the electric vehicle is selected from the group consisting of an electric car, a hybrid car, an electric truck, a hybrid truck, an electric boat, a hybrid boat, an electric scooter, a hybrid scooter, an electric motorcycle and a hybrid motorcycle.
